(19) United States
(12) Patent Application Publication
(10) Pub. No.: US 2017/0030278 A1
(43) Pub. Date: Feb. 2, 2017

(54) REDUCING FIRING DECISION LATENCY IN SKIP FIRE ENGINE OPERATION

(71) Applicant: Tula Technology, Inc., San Jose, CA (US)

(72) Inventor: Andrew W. PHILLIPS, Rochester, MI (US)

(21) Appl. No.: 14/812,370

(22) Filed: Jul. 29, 2015

(51) Int. Cl. F02D 41/00; F02D 41/26

(52) U.S. Cl. CPC F02D 41/0087; F02D 41/263

(57) ABSTRACT

Techniques and controllers are described for dynamically determining when to request firing decisions for individual firing opportunities while operating an internal combustion engine in a skip fire mode. In one aspect, a skip fire controller is arranged to periodically determine the timing by which a next cylinder firing decision request must be made in order to assure that a corresponding firing decision can be implemented as desired, and whether there is sufficient time to wait until at least the next periodic timing determination is made to request the next cylinder firing decision. When there is not sufficient time to wait, a firing decision request is made and the corresponding working cycle is either skipped or fired based on the received firing decision. When there is sufficient time to wait, the firing decision request is delayed until at least the next periodic timing determination is made.

### FIELD

The present invention relates generally to skip fire control of an internal combustion engine. More particularly, techniques are described for reducing the latency between the time when a fire/no-fire decision is made and the torque resulting from such a decision is actually generated.

### BACKGROUND

The Applicant has developed a technology for improving the fuel efficiency of an engine by operating the engine in a dynamic skip fire mode. In general, skip fire engine control contemplates selectively skipping the firing of certain cylinders during selected firing opportunities. Thus, a particular cylinder may be fired during one engine cycle and then skipped during the next engine cycle and either skipped or fired during the next. With dynamic skip fire, firing decisions may be made on a firing opportunity by firing opportunity basis, as opposed to simply using predefined firing patterns. By way of example, representative dynamic skip fire controllers are described in U.S. Pat. No. 8,099,224 and U.S. application Ser. No. 13/654,244, both of which are incorporated herein by reference.

Skip fire engine operation is distinguished from conventional variable displacement engine control in which a designated set of cylinders are deactivated substantially simultaneously and remain deactivated as long as the engine remains in the same variable displacement mode. Thus, the sequence of specific cylinders firings will always be exactly the same for each engine cycle during operation in a variable displacement mode (so long as the engine remains in the same displacement mode), whereas that is often not the case during skip fire operation. For example, an 8 cylinder variable displacement engine may deactivate half of the cylinders (i.e. 4 cylinders) so that it is operating using only the remaining 4 cylinders. Commercially available variable displacement engines available today typically support only two or at most three fixed mode displacements. In general, skip fire engine operation facilitates finer control of the effective engine displacement than is possible using a conventional variable displacement approach. For example, firing every third cylinder in a 4 cylinder engine would provide an effective displacement of ⅓^{rd} of the full engine displacement, which is a fractional displacement that is not obtainable by simply deactivating a set of cylinders.

Given the nature of engine operation, there is an inherent delay between the time a firing decision is made and the time that the corresponding torque is generated. The present application describes techniques for reducing such delays.

### SUMMARY

To achieve the foregoing and other objects of the invention, techniques and controllers are described for dynamically determining when to request firing decisions for individual firing opportunities while operating an internal combustion engine in a skip fire mode. In one aspect, the skip fire controller is arranged to periodically determine the timing by which a next cylinder firing decision request must be made in order to assure that a corresponding firing decision can be implemented as desired and whether there is sufficient time to wait until at least the next periodic timing determination is made to request the next cylinder firing decision. When there is not sufficient time to wait, a firing decision request is made and the corresponding working cycle is either skipped or fired based on the received firing decision. When there is sufficient time to wait, the firing decision request is delayed until at least the next periodic timing determination is made.

In some embodiments, the periodic timing determinations are made at set intervals of time, as for example, approximately every millisecond. In other embodiments, the periodic timing determinations are made at set intervals of crankshaft rotation, as for example, every 30 degrees of crankshaft rotation. Of course, the length of the specific intervals used may vary widely with the needs of any particular implementation.

The periodic timing determination preferably accounts for: (i) current engine speed; and (ii) the reaction time of the first actuator that potentially needs to be actuated in order to implement either a fire or no-fire decision. In various embodiments, the periodic timing determinations may further account for: (iii) a decision making interval indicative of the amount of time required to obtain the firing decision; and/or (iv) a desired safety padding, wherein the desired safety padding at least assures that engine speed variations do not cause any firing decisions to be received too late to be implemented.

In some embodiments, a single routine makes the periodic timing determinations for all of the cylinders operating in the skip fire mode. In other embodiments, separate routines are provided for each of the cylinders operating in the skip fire mode.

The periodic timing determinations may be made by an engine/power train control unit, by a skip fire controller arranged to communicate with an engine/power train engine control unit over a controller area network (CAN bus) or by any other suitable logic.

In another aspect the relative crank angle at which a firing decision is made relative to the associated firing opportunity (e.g. the beginning of the corresponding power stroke) varies as a function of engine speed and potentially other engine operating parameters such as oil pressure. With the described approach, the firing decisions may be made at a later crankshaft angle relative to the firing opportunity at lower engine speeds than at higher engine speeds.

### BRIEF DESCRIPTION OF THE DRAWINGS

The invention and the advantages thereof, may best be understood by reference to the following description taken in conjunction with the accompanying drawings in which:

FIG. 1 is a flow chart illustrating a firing decision timing control algorithm in accordance with one embodiment.

FIG. 2 is a timing diagram illustrating the timing of representative actuator pulses that might be associated with cylinder deactivation relative to a working cycle of a cylinder of an engine operating at a relatively high engine speed.

FIG. 3 is a segment of a timing diagram similar to FIG. 2 illustrating the occurrence of selected periodic checks relative to intake valve actuator timing in accordance with a specific example.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

During operation of an engine in a dynamic skip fire mode, there is typically a delay between the time when a firing decision (i.e., a fire/no-fire decision) is made and the occurrence of corresponding combustion event that generates torque (or lack thereof) based on such a decision. Generally, the shorter the latency (delay) is between making a firing decision and the corresponding torque consequences, the more responsive the engine can be. Therefore, there are potential advantages, to reducing the latency.

There are a number of factors that may contribute to the latency. Part of the delay is due to the nature of multi-stroke engine operation. For example, to reduce pumping losses, it is often desirable to “deactivate” the working chambers (e.g., cylinders) during skipped working cycles in order to prevent air from being pumped through the cylinders. In some implementations cylinder deactivation is accomplished at least in part by disabling the intake valve such that the intake valve is not opened and air is not introduced into the corresponding cylinder during skipped working cycles. In such implementations the fire/no-fire decision must, at a minimum, be made by the time the intake stroke begins. This inherently imparts a delay of at least one engine revolution between the firing decision and the corresponding firing opportunity—i.e., the delay corresponding to the intake and compression strokes.

Another factor that affects latency is the time required to actuate components that need to be activated or deactivated based on whether the decision is to skip or fire. For example in engines having cam actuated valves, a variety of different systems have been proposed for deactivating cams, including various lost motion spring based devices, UniAir systems, sliding cam based systems, etc. (A few such systems are described in the paper “Statische und Dynamische Zylinderabschaltung an 4-und 3-Zylindermotoen” presented by Schaeffler Technologies GmbH & Co. KG in Proceedings of the Intemationaler Motorenkongress 2015, Feb. 24-25, Baden-Baden, Germany, pp. 331-352). Most such systems include hydraulic and/or electromechanical actuating components that take some time to actuate. Similarly, in port fuel injection systems, the fuel injector typically must be activated or deactivated prior to the intake stroke.

In order to assure proper operation, the firing decision must be made far enough in advance to insure that the relevant actuator can safely be activated or deactivated appropriately in response to a firing decision. For example, consider a component that has a 10 millisecond response time (e.g., that takes 10 ms to activate). When an engine is operating at 1200 RPM, 10 ms corresponds to 72 degrees of crankshaft rotation. The same 10 ms response time corresponds to 60° of crankshaft rotation at 1000 RPM, 120° at 2000 RPM, 180° at 3000 RPM, 240° at 4000 RPM, and 300° at 5000 RPM.

The response times of various components are not always the same under all operating conditions. For example, many valve deactivation components are hydraulically operated and thus their response time may vary as a function of the pressure within the hydraulic system (typically, but not necessarily, the engine oil pressure) or other engine operating parameters.

Many engine control decisions are triggered based on the rotational position of the crankshaft—often referred to as the crank angle. Thus one dynamic skip fire control approach is to make the firing decisions at a designated crank angle relative to a particular reference such as the beginning of a working cycle or the beginning of a “combustion” stroke. In such an approach, the event timing is typically chosen based on “worst-case” operating conditions. Thus, there are a number of factors that may influence the designated decision timing—including the response time of relevant components, the maximum supported operational engine speed, desired safety margins, etc. For example, in some implementations, a reasonable and safe decision timing might be something on the order of 1 working cycle (i.e., 2 revolutions or 720°) before the relevant working cycle begins. In a four stroke engine, the combustion stroke begins one revolution (360°) after the working cycle begins and thus, the firing decisions would be made 3 revolutions or 1080° before the corresponding torque is actually realized. In an 8-cylinder engine, that corresponds to 12 firing opportunities, which is to say that any time a firing decision is made, 12 other fire/skip events are executed before the effects of that decision are realized. At an engine speed of 1200 RPM, that delay corresponds to 150 ms. Although such a system works well, it is generally desirable to further reduce latency when practical without the need to resort to (or at least reducing the need to use) fuel wasting techniques such as retarding the spark timing, etc.

In some described embodiments, the latency associated with firing decisions can be reduced by more actively managing the firing decision timing based at least in part on current engine operating conditions. In principle, a firing decision timing control algorithm determines when firing decisions must be made based on current operating conditions and requests firing decisions at the appropriate time. In most operating conditions, this allows the firing decisions to be made closer to the time that the corresponding torque is realized than is practical using the fixed timing approach. In particular, having a fixed decision timing based on worst case conditions imposes significant control delays when the engine is operating at lower engine speeds.

In practice, there are several factors that may influence the minimum time required to make a firing decision. One factor is the actual response time of the component that must be actuated first in order to implement a skip or fire decision—which is referred to herein as the longest lead actuator response time T_{A}. In most dynamic skip fire applications that contemplate cylinder deactivation during skipped working cycles in engines incorporating a camshaft driven valve train, the time critical feature will be the response time the actuator that activates or deactivates the intake valves (with the longer of the activation and deactivation response times being the critical feature). However, in other embodiments other components may be the longest lead component. For example, when the cylinder management during skip fire operation contemplates the use of intake air springs in skipped working chambers or cylinder deactivation is not utilized, then other actuators such as the fuel injectors (particularly in port injected engines) may be the limiting factor. Conversely, if cylinder management contemplates trapping high pressure exhaust gases in the working chambers during skipped working cycles, then the actuator for the exhaust valve associated with the previous working cycle may be the limiting factor (longest lead component).

In some circumstances, the component that needs to be actuated first may vary based on an engine operating parameter such as engine speed, mode of skip fire operation, hydraulic pressure, etc. Regardless, the longest lead component (i.e. the component requiring the earliest fire/no fire decision) and its associated response time is generally known or can be readily estimated or determined based on current operating condition. In many circumstances, the actuator response time T_{A} may be considered a constant. However, in alternative embodiments, the response time T_{A} can be treated as a variable based on any relevant parameters including the current state of the actuator (e.g., activated or deactivated).

Another relevant factor is the delay d_{D} associated with the round trip response time required to obtaining a firing decision. That is the time required to issue a firing decision request, make a firing decision and receive the firing decision in response. In many implementations, the firing request response delay d_{D} will be negligible and this factor can be ignored or included in the padding. However, in some embodiments the firing request response delay d_{D} can be significant and should be explicitly considered. One example of a circumstance in which the firing request response time delay d_{D} might be significant is when the skip fire controller that makes the firing decision communicates with an engine controller over a network such as a controller area network (CAN bus) as might be the case when the skip fire controller is implemented as a co-processor embodied in a different chip than an engine control unit (ECU). In contrast, when the skip fire control functionality is incorporated into a single chip engine control unit, the firing decision request response time d_{D} might be negligible.

The correlation between a specific time delay and the corresponding angular rotation of the crankshaft will vary with engine speed. For example, at 1200 RPM, 50 ms corresponds to one revolution of the crankshaft, whereas at 3000 RPM 50 ms corresponds to 900° of crankshaft rotation. Thus the number of engine cycles or crankshaft rotations ahead of time that a firing decision practically needs to be made will vary with the engine speed. During normal engine operation, the engine speed can change rather rapidly and such variations can significantly impact transformations between the time and crank-angle domains. To account for these (and other) variations, a safety delay or padding d_{P} is preferably added to the minimum firing decision timing to help assure that engine speed variations (and other variations) don't cause errors. The desired padding can be a constant in either the time or crank angle domain, or it can be a variable based on the current engine operating speed, etc.

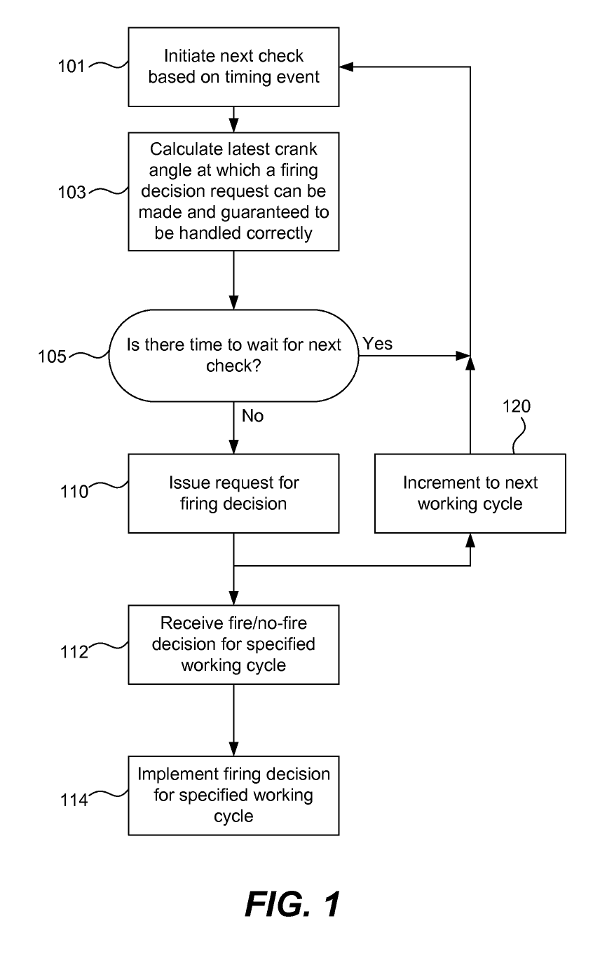

Referring next to FIG. 1, a “just-in-time” firing decision timing control algorithm in accordance with one embodiment will be described. In general, at regular intervals, a check is made as to whether a firing decision needs to be made before the next check is performed. Thus, checks are periodically initiated based on a timing event as represented by step 101. The timing event may be time based, such as every 1 ms, 0.5 ms, 2.0 ms, etc. or it may be crank angle based such as every 30°, every 90° of crankshaft rotation, etc. When the check is initiated, a calculation is made as to the latest time or crank angle at which a firing decision request can be made for a specified working cycle while guaranteeing that the resulting fire/no-fire decision can be implemented correctly as represented by step 103. The determination can be made with respect to any given reference point. In many modern engine controllers (e.g. engine control units, powertrain control modules, etc.) the timing of many engine control operations are based on crank angle. That is, certain control operation may be initiated, repeated, etc. at specific crank angles or at periodic angular intervals such as every 30°, every 90°, etc. Therefore, in the illustrated embodiment, the reference point is the top dead center (TDC) piston position associated with the beginning of the working cycle of interest, i.e. the start of the intake stroke, and the calculations are made in terms of crank angle degrees before that reference position (BTDC). However, in other embodiments, other reference points can be used and the calculations may be made in the time domain or any other appropriate domain.

In a specific example, the timing by which a particular firing decision T_{R} must be made can be calculated as follows:

T_{R}=T_{A}+d_{D}+d_{P}

Wherein T_{A} is the critical actuator response time; d_{D} is the delay associated with the round trip response time to obtain a decision (which is optionally used if relevant); and d_{P} is the safety padding delay.

Once the firing decision timing is determined, step 105 determines whether there is enough time to wait until the next iteration of the timing check. This can be represented mathematically by the logical expression:

is T_{C}<T_{R}−d_{S}

where T_{C} is the current angular position of the crankshaft and d_{S} is the delay before the next check is made.

When there is sufficient time to wait for the next check the logic returns to step 101 where it awaits the timing event that triggers the next check. Alternatively, if it is determined that there is not sufficient time to wait for the next check, then a firing decision request is sent to the skip fire control logic (step 110), which may take the form of a sigma delta converter as described in some of the incorporated patents or any other suitable skip fire control logic. Thereafter the engine controller receives (step 112) and implements (step 114) the firing decision for the specified working cycle.

In parallel, the firing decision timing control algorithm increments to the next working cycle (step 120) and repeats the process for the next working cycle.

An advantage of the described approach is that the firing decisions can be delayed as long as practical based on the current operating state of the engine and control algorithm constraints. This allows the skip fire controller to be more responsive to changing conditions in many circumstances, including most notably at lower engine speeds.

Although a specific algorithm has been described, it should be appreciated that there are a wide variety of different approaches that can be used to implement “just-in-time” firing decisions. As previously described, the determinations may be made in the time domain, in the crank angle domain, or any other appropriate domain. In some implementations a separate firing decision timing control algorithm may be provided for each cylinder, optionally with all of the separate algorithms working under a supervisory routine. Alternatively, a single routine may be used to determine the appropriate timing for all of the cylinders. In still other implementations, multiple routines can be provided with each routine handling a subset of the cylinders.

Preferably, the firing decision timing control algorithm runs at a rate that is faster than the rate at which decision for the engine as a whole are needed. For example, in a V8 engine, decisions are needed every 90 degrees on average. However when the engine speed is increasing rapidly the decisions will be needed more often (e.g., within 70 degrees), whereas as the engine speed slows, the decisions would be needed at intervals slightly larger than 90°. Generally, making timing checks at a rate of at least 1.3 times the rate that firing decisions are needed is sufficient to account for such variations in engine speed.

The described approach works most cleanly when the checking routine operates at a significantly faster rate than the firing opportunities, as for example every 30° or every 1 ms for an eight cylinder engine or at least 30% faster than the rate at which firing decisions are needed. This ensures that requests for decisions for two consecutive cylinders will never happen simultaneously. However, as will be appreciated by those familiar with the art, some automotive manufactures are highly reluctant to access to engine controller resources at intervals that frequent.

Even when the firing decision timing control algorithm executes at a rate closer to the rate at which decisions for the engine are needed (e.g. every 90°) or slower, the described approach works well. One way to handle such situations is to provide a separate control routine for each cylinder. However, even if a single routine is used in such circumstances, the algorithm can readily be adjusted to check multiple (e.g., 2) cylinders simultaneously and to send multiple firing decisions requests simultaneously when operating conditions warrant.

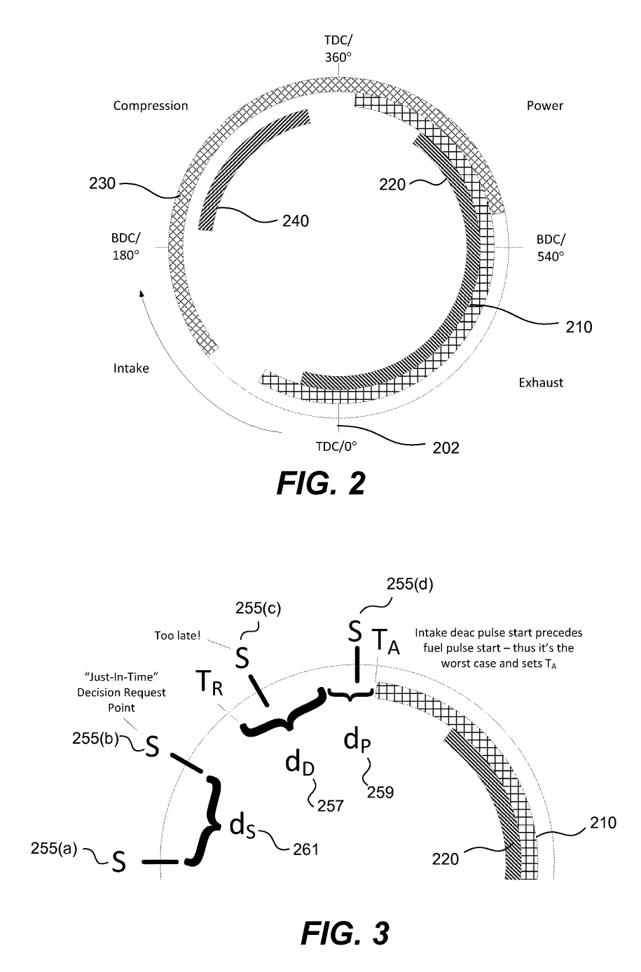

FIG. 2 illustrates the timing of various actuator pulses that may be required inactivate or deactivate a cylinder during skip fire operation at a relatively high engine speed. The drawing represents a single working cycle of a 4-stroke piston engine, which corresponds to 720° of crankshaft rotation and begins at point 202 located at the bottom of the figure. The four strokes, intake, compression, power, and exhaust, occur between successive TDC and BDC piston positions. This cycle repeats and actions taken in an earlier cycle may inform actions that occur in a subsequent cycle. The timing associated with the actuation of four representative components are shown—specifically intake valve deactivation pulse 210, fuel injection pulse 220, exhaust valve deactivation pulse 230 and spark pulse 240. In the particular embodiment shown, the intake deactivation pulse 210 must begin close to 360 degrees before the working cycle begins and fuel injector activation pulse 220 follows shortly thereafter. The exhaust valve deactivation pulse 230 and the spark pulse 240 come much later in the cycle. The leading clockwise edge of the various pulses, 210, 220, 230 and 240 indicates when the pulse must be initiated. The duration of the signal is indicated by the length of the arc associated with the pulse. The pulse 220 shown is representative of a port fuel injected engine. The pulses 210 and 230 shown are representative of the control of a lost motion valve lifter for deactivation of the intake valve and exhaust valve, respectively. The spark pulse 240 shown is representative of the charging time necessary to generate a spark. The spark would occur at the end of the pulse 240. It should be appreciated that for direct injection engines and engines that use other forms of cylinder deactivation the length and timing of the pulses 210, 220, and 230 may be different, but the concepts described herein are still applicable.

In the illustrated example, if both the intake and exhaust valves are to be deactivated during skipped working cycles so that no air or high pressure gases are trapped within the cylinder, then the earliest decision is associated with intake valve deactivation pulse 230. However, if the valve actuation scheme contemplates trapping an air charge within the cylinder, then the fuel injection pulse 220 would be the component requiring the earliest decision. Alternatively, if the valve actuation scheme contemplates the use of high pressure air springs (i.e. trapping exhaust gases from the previous working cycle in the cylinder), then the exhaust valve deactivation pulse 230 associated with the previous working cycle would have the earliest decision time.

FIG. 3 is an enlarged view of a portion of the working cycle illustrated in FIG. 2 that superimposes the timing of periodic checks 255a-255d (each denoted by S and separated by a delay between checks 261 (d_{S})), a response time delay 257 (d_{D}), and a safety padding delay 259 (d_{P}) in an effort to illustrate the practical effect of the algorithm of FIG. 1. As seen therein, based on the response time of the intake valve actuator (which is the longest lead actuator for the working cycle—T_{A}), the response time delay (d_{D}) and desired safety padding (d_{P}), the request for a firing decision must be made by time T_{R}. Checks S are periodically made at intervals d_{S}, corresponding to 30° in this example, as illustrated by timing checks 255(a), 255(b), 255(c) and 255(d). T_{R} falls between checks 255(b) and 255(c) and therefore must be initiated at timing check 255(b) since that is the last periodic check which can assure that the resulting fire/no-fire decision can be implemented correctly.

Although a specific example is shown in FIGS. 2 and 3 for illustrative purposes, it should be appreciated that the actual timing of the actuator components can vary widely as a function of engine speed, the specific actuating components used, the valve actuation strategy and other engine operating parameters.

As mentioned above, one approach to firing decision timing is to always request the firing decision at the same timing—as for example, 1 working cycle) (720° before a working cycle begins which is a reasonable approach for a cam actuated valve train when high pressure exhaust springs are supported (i.e., the exhaust valves are deactivated after a firing event so that high pressure combusted gases are maintained within the cylinder during skipped working cycles). Under such an approach, the torque consequences of a firing decision tend to begin about 1080° after the firing decision, which translates to 12 firing opportunities in an eight cylinder engine. That number can be reduced to the order of 9 firing opportunities) (810° by not supporting high pressure exhaust springs. Using the described approach described with reference to FIG. 1 and not supporting high pressure exhaust springs, the number can be further reduced to the order of 5-9 firing opportunities (450° to 810° of crankshaft revolution) which is a significant improvement in responsiveness. The improvement varies with engine speed with greater improvements being seen at lower engine speeds and less improvement being available as the engine speed increases because the fixed value is typically based on worst cases scenarios, which is at the highest engine speed at which skip fire operation is supported. The result is that the response time tends to be more consistent in the time domain, which is very useful since the longer delays associated with low speed engine operation tend to be the most noticeable to the driver.

Although the improvement has been described in part in terms of the reduced number of firing opportunities that occur between a firing decision and the major torque consequences associated with that firing decision, it should be appreciated that such numbers are highly dependent on the number of operating cylinders. Thus, it is often more relevant to consider the improvement in terms of crankshaft timing. Significantly, the advanced timing in terms of crank angle at which decisions must be made is less at lower speeds than at higher speeds and at some lower engine speeds, the delay between a firing decision and the corresponding firing opportunity/torque consequences can be less than 540° of crankshaft revolution, which is quite significant.

Although only a few embodiments have been described in detail, it should be appreciated that the invention may be implemented in many other forms without departing from the spirit or scope of the invention. For example, most of the examples have been described in the context of skip fire operation in which the intake valve(s) is/are deactivated during skipped working cycles such that air is not introduced into the associated working chambers and the actuator associated with intake valve activation/deactivation is the earliest lead time component associated within a working cycle. However, it should be appreciated that the same concepts apply regardless what component requires the earliest lead time.

In the primary illustrated embodiment, the checks are made at regular periodic intervals and when it is determined that the firing decision request cannot wait until the next periodic check, the firing decision request is sent immediately with no effort being made to wait until closer the last possible moment T_{R} to send the request which works well in practice. However, in other embodiments, the request could be further delayed to a time closer to T_{R} if such delays are consistent with other engine controller protocols. Thus, although regular (e.g. consistent) periodic intervals are primarily described here, it should be appreciated that the periodic intervals do not need to be regular or consistent in length, time or crank angle displacement.

The described algorithms can be implemented using software code executing on a processor associated with an engine control unit or powertrain control module or other processing unit, in programmable logic or discrete logic. The described approach is particularly well suited for use on engines having multiple working chambers although the same approach can be used on a single cylinder engine as well. It is expected that the approach will Therefore, the present embodiments should be considered illustrative and not restrictive and the invention is not to be limited to the details given herein, but may be modified within the scope and equivalents of the appended claims.

What is claimed is:

1. A method of dynamically determining when to request firing decisions for individual firing opportunities while operating an internal combustion engine in a skip fire mode, the method comprising establishing a sequence of timing checks, wherein each timing check includes:
determining a timing by which a next cylinder firing decision request must be made in order to assure that a corresponding firing decision can be implemented as desired;
making a firing decision request when it is determined that there is not sufficient time to wait until at least the next timing check to request the next cylinder firing decision; and
delaying the firing decision request when it is determined that there is sufficient time to wait until at least the next timing check is made to request the next cylinder firing decision.

2. A method as recited in claim 1 further comprising:
receiving a firing decision in response to the firing decision request; and
either skipping or firing a cylinder based on the received firing decision.

3. A method as recited in claim 1 wherein the timing checks are made at set time intervals.

4. A method as recited in claim 3 wherein the set time intervals are approximately a millisecond.

5. A method as recited in claim 1 wherein the timing checks are made at set intervals of rotation of a crankshaft.

6. A method as recited in claim 5 wherein the set intervals of rotation are at least 30 degrees of crankshaft rotation.

7. A method as recited in claim 1 wherein the timing by which a next cylinder firing decision request must be made in order to assure that a corresponding firing decision can be implemented varies based on current engine speed and accounts for the reaction time of a first actuator that is the earliest actuator that may be required to actuate in order to implement the firing decision.

8. A method as recited in claim 7 wherein the timing by which a next cylinder firing decision request must be made in order to assure that a corresponding firing decision can be implemented further accounts for a decision making interval indicative of the amount of time required to obtain the firing decision.

9. A method as recited in claim 1 wherein the timing by which a next cylinder firing decision request must be made in order to assure that a corresponding firing decision can be implemented further accounts for a desired safety padding, wherein the desired safety padding at least assures that engine speed variations do not cause any firing decisions to be received too late to be implemented.

10. A method as recited in claim 1 wherein a single routine makes the timing checks for each of the cylinders operating in the skip fire mode.

11. A method as recited in claim 1 wherein a separate routine is provided for each cylinder operating in the skip fire mode and each routine makes the timing checks for an associated cylinder.

12. A method as recited in claim 1 wherein the timing checks are made at a frequency that is at least 1.3 times as fast as firing decisions are needed.

13. A method as recited in claim 7 wherein the first actuator is an actuator arranged to cause an intake valve to be active or to cause the intake valve to be deactive.

14. A method as recited in claim 1 wherein the timing checks are not made when the engine exceeds a designated engine speed threshold.

15. A method as recited in claim 1 wherein the crank angle at which firing decisions are made varies based on at least one engine operating parameter.

16. A method as recited in claim 15 wherein the at least one engine operating parameter includes at least one of engine speed and oil pressure.

17. A method as recited in claim 1 wherein the engine is a multi-cylinder engine.

18. A method as recited in claim 1 wherein the engine is a single cylinder engine.

19. A firing decision request timing determining unit arranged to determine the timing of firing decision requests during operation of an engine in a skip fire operational mode, the firing decision request timing determining unit being arranged to:
periodically determine a timing by which a next cylinder firing decision request must be made in order to assure that the corresponding firing decision can be implemented as desired;
make a firing decision request for the next firing opportunity when it is determined that there is not sufficient time to wait until at least the next periodic timing determination is made to request the next cylinder firing decision; and
delaying the firing decision request for the next firing opportunity when it is determined that there is sufficient time to wait until at least the next periodic timing determination is made to request the next cylinder firing decision.

20. An engine control unit arranged to direct operation of an engine in a skip fire operational mode, the engine control unit including a firing decision request timing determining unit as recited in claim 19.

21. A skip fire controller arranged to communicate with an engine control unit or a power train control unit over a controller area network (CAN bus), the skip fire controller including a firing decision request timing determining unit as recited in claim 19.

22. A method of controlling the operation of an internal combustion engine in a skip fire mode, the engine having a crankshaft and a plurality of working chambers, each working chamber being arranged to operate in series of working cycles, the method comprising:
making a fire/no-fire decision for each working cycle, each working cycle having an associated firing opportunity at which point a combustion event occurs in response to a fire decision and is skipped in response to a no-fire decision; and
wherein the amount of crankshaft rotation that occur between a fire/no fire decision and the associated firing opportunity varies based on at least one engine operating parameter.

23. A method as recited in claim 22 wherein the at least one engine operating parameter includes engine speed and the firing decisions are made at a later crankshaft angle relative to the firing opportunity at lower engine speeds than at higher engine speeds.

24. A method as recited in claim 22 wherein at some engine speeds, the firing decisions are made less than 540 degrees of crankshaft rotation before the associated firing opportunity.

25. A method as recited in claim 22 wherein the at least one engine operating parameter includes oil pressure.
